(19) United States
(12) Patent Application Publication
(10) Pub. No.: US 2016/0292707 A1
(43) Pub. Date: Oct. 6, 2016

(54) PARKING FACILITY OCCUPANCY MANAGEMENT USING RETAIL INCENTIVES

(71) Applicant: International Business Machines Corporation, Armonk, NY (US)

(72) Inventors: Sebastien Blandin, Singapore (SG); Kenneth Scea, Poughkeepsie, NY (US); Laura Wynter, Singapore (SG); Sha Sha Yang, Singapore (SG)

(21) Appl. No.: 14/674,677

(22) Filed: Mar. 31, 2015

(51) Int. Cl. G06Q 30/02; G07B 15/00

(52) U.S. Cl. CPC G06Q 30/0226; G07B 15/00

(57) ABSTRACT

In an approach to manage parking facility occupancy, a computing device retrieves a customer identification for a customer entering a parking facility and determines whether a customer profile is available for the customer. Upon determining the customer profile is available, the computing device retrieves the customer profile from a database. Additionally, the method includes the computing device determining, based, at least in part, on the customer profile, a customer spending level for the customer. Furthermore, the computing device determines whether an alert is received, the alert indicating a parking facility occupancy level is predicted to attain an alert threshold level. In response to determining the alert is received, the computing device determines a retail incentive for the customer, based, in part, on the customer spending level.

### BACKGROUND OF THE INVENTION

The present invention relates generally to the field of parking facility occupancy management and more particularly to the use of retail incentives to reduce parking facility congestion.

In large metropolitan areas, in particular, locating an available parking space can be problematic. A number of applications have been developed to aide motorists in finding an unoccupied parking space and the car location when returning to the parking facility. Parking facilities utilize a variety of technologies to aide motorists using a parking facility. Parking facilities may include adaptive lighting, sensors, indoor positioning systems, and mobile payment options such as smart wallets. Statistical modelling is used to forecast parking occupancy in some locations.

Online booking technology service providers or on-line parking facility booking services help drivers find long-term parking in an automated manner, while also providing significant savings for those who book parking spaces ahead of time. The on-line booking service providers use real-time inventory management technology to display parking lots with availability, sorted by price and distance from select locations such as an airport. Additionally, there are mobile applications providing services for the reservation of long-term parking lot spaces similar to online parking facility booking services. Some long-term parking mobile applications also have turn-by-turn maps to locate the parking facility.

### SUMMARY

Embodiments of the present invention disclose a method, a computer program product, and a system to manage parking facility occupancy. The method includes a computing device retrieving a customer identification for a customer entering a parking facility and determining whether a customer profile is available for the customer. Upon determining the customer profile is available, the computing device retrieves the customer profile from a database. Additionally, the method includes the computing device determining, based, at least in part, on the customer profile, a customer spending level for the customer. Furthermore, the computing device determines whether an alert is received, the alert indicating a parking facility occupancy level is predicted to attain an alert threshold level. In response to determining the alert is received, the computing device determines a retail incentive for the customer, based, in part, on the customer spending level.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a retail incentive program, on a server computer within the distributed data processing environment of FIG. 1, for determining retail incentives for customers using a parking facility, in accordance with an embodiment of the present invention; and

FIG. 3 depicts a block diagram of components of a computer system, which is an example of a system such as the server within the distributed data processing environment of FIG. 1, in accordance with an embodiment of the present invention.

### DETAILED DESCRIPTION

Embodiments of the present invention recognize that the availability of parking spaces in a parking facility is often limited. Embodiments of the present invention provide a method to reduce parking facility congestion by predicting, based in part on historical parking occupancy data, when expected high occupancy levels occur in the parking facility, and using retail incentives to promote customers to make purchases and exit the parking facility during periods of predicted high parking occupancy levels. Embodiments of the present invention use a parking model with an automatic alert capability when predicted parking occupancy levels attain an alert threshold level. Additionally, embodiments of the present invention use a retail incentive program determining retail incentives to increase revenues for retailers, based on the receipt of the alert indicating a predicted high parking occupancy level, and aid in the management of the parking facility occupancy. Implementation of embodiments of the invention may take a variety of forms, and exemplary implementation details are discussed subsequently with reference to the Figures.

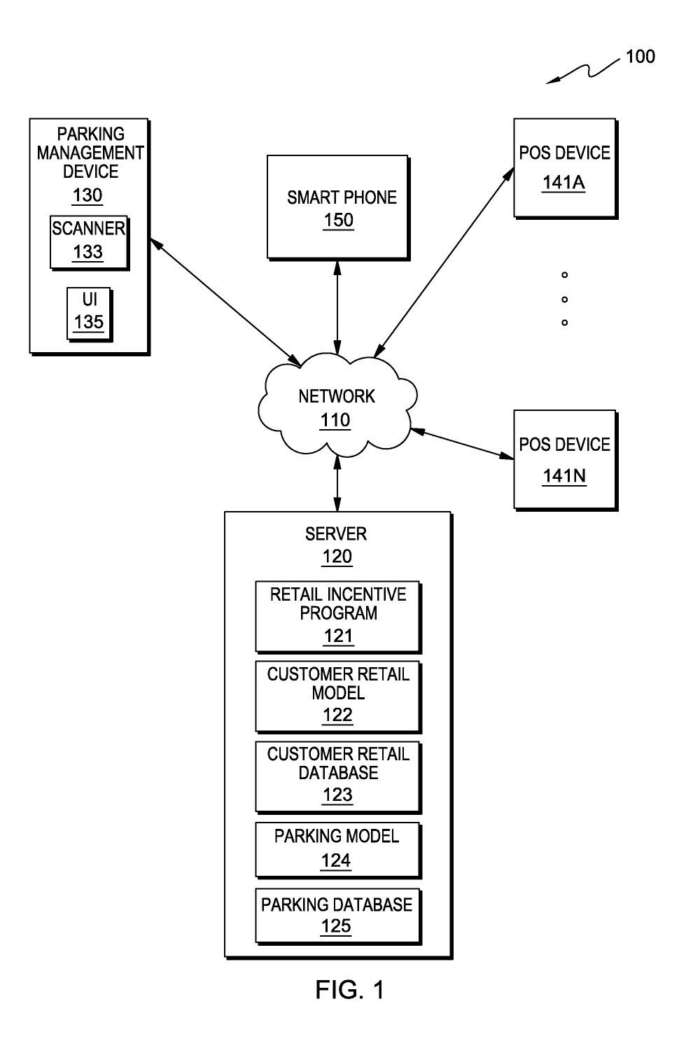

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 120, parking management device 130, point of sale devices 141A to 141N, and smartphone 150, all interconnected over network 110. Network 110 can be, for example, a telecommunications network, a local area network (LAN), a wide area network (WAN), such as the Internet, or a combination of the three, and can include wired, wireless, or fiber optic connections. Network 110 can include one or more wired and/or wireless networks that are capable of receiving and transmitting data, voice, and/or video signals, including multimedia signals that include voice, data, and video information. In general, network 110 can be any combination of connections and protocols that will support communications between server 120, parking management device 130, point of sale (POS) devices 141A to POS device 141N, smartphone 150 and other computing devices (not shown) within distributed data processing environment 100.

Server 120 can be a standalone computing device, a management server, a web server, a mobile computing device, or any other electronic device or computing system capable of receiving, sending, and processing data. In other embodiments, server 120 can represent a server computing system utilizing multiple computers as a server system, such as in a cloud computing environment. In another embodiment, server 120 can be a laptop computer, a tablet computer, a netbook computer, a personal computer (PC), a desktop computer, a personal digital assistant (PDA), a smart phone, or any programmable electronic device capable of communicating with parking management device 130, point of sale devices 141A to 141N, smartphone 150, and other computing devices (not shown) within distributed data processing environment 100 via network 110. In another embodiment, server 120 represents a computing system utilizing clustered computers and components (e.g., database server computers, application server computers, etc.) that act as a single pool of seamless resources when accessed within distributed data processing environment 100. Server 120 includes retail incentive program 121, customer retail model 122, customer retail database 123, parking model 124, and parking database 125.

Retail incentive program 121 resides on server 120. Retail incentive program 121 receives from parking model 124 alerts when the predicted parking occupancy level determined by parking model 124 is predicted to reach a predetermined parking occupancy threshold or an alert threshold level. When retail incentive program 121 receives an alert that the parking facility occupancy is predicted to reach the alert threshold level, retail incentive program 121 determines the appropriate retail incentives to send to customers using the parking facility to encourage them to make purchases and exit the parking facility. The retail incentives can be sent via an application such as a retail incentive application on smartphone 150 to the customer. The retail incentives are determined to increase revenue in the facility such as a shopping mall or other associated retailers (e.g., theaters or restaurants) using the parking facility, and to reduce parking congestion. Retail incentive program 121 provides incentives such as parking discounts to encourage current customers to make purchases and leave the parking facility to provide parking space for additional customers when an alert is received. Retail incentive program 121 determines the appropriate retail incentives by one or more of several methods. In one embodiment, retail incentive program 121 joins POS transaction data from retailers whose customers use the parking facility, using a customer profile, to the parking occupancy levels identified using the alerts to determine an appropriate incentive for a customer to increase or complete purchases. Retail incentive program 121 uses the customer profile created by customer retail model 122, in part, from retailer provided POS transaction data retrieved from customer database 125. The customer profile used by retail inventive program 121 may include customer related data retrieved from parking database 125. When the parking facility is predicted to attain the alert threshold level and a customer profile is available in customer retail database 125, retail incentives are determined and provided to customers. The retail incentives sent to select customers or, in some cases, to each customer using the parking facility encourage customers to complete purchases in a timely manner and exit the parking facility making room for additional customers when an alert is received. When no alerts have been received, retail incentive program 121 may send retail incentives to select customers to stay and increase spending. Retail incentive program 121 sends retail incentives to customers via a smart phone application, a text, an e-mail, or another form of electronic communication.

Customer retail model 122 resides on server 120. In various embodiments, customer retail model 122 determines a customer profile for the customer retail spending patterns based, in part, on historical customer retail transaction data from POS devices 141A to 141N retrieved from customer retail database 123. For example, customer retail model 122 retrieves from customer retail database 123 historical and real-time POS transaction data for customers from retailers such as stores, restaurants, theaters, or sports venues. In an embodiment, customer retail model 122 refreshes or retrieves data on a pre-determined time schedule. For example, customer retail model 122 retrieves customer retail transaction data such as POS transaction data every ten minutes. In one embodiment, customer retail model 122 retrieves only customer transactions that have occurred since the last refresh or data retrieval. In another embodiment, when customer retail model 122 receives a query or a search request for a customer profile that is not present (i.e., no retail transaction data has been retrieved for the customer), then customer retail model 122 sends a query to customer retail database 123 to retrieve any recent retail transactions for that customer that may have occurred since the last data refresh. Customer retail model 122 can retrieve POS transaction data for retailers who elect to send customer transaction data to customer retail database 123 and whose customers may use the parking facility monitored by parking management device 130. In an embodiment, customer retail model 122 determines a customer profile based on historical customer retail transaction data such as POS transaction data from another database not resident on server 120. A customer profile determined by customer retail model 122 from the historical customer retail transaction data received from customer retail database 123 may include one or more of the following: customer name, customer payment method, customer spending profile (e.g., how much a customer typically spends), products typically purchased, the stores commonly purchased from, order of purchases, customer cell phone number, customer e-mail address, average length of parking facility use, customer spending as a function of length of parking facility use, and any other specific customer transaction patterns that may be retrieved from POS transaction data stored in customer retail database 123. In the exemplary embodiment, customer retail model 122 stores the customer profile in customer retail database 123 on server 120. In an embodiment, customer retail model 122 sends the customer profile to smartphone 150 or another computing device associated with the user.

In an embodiment, customer retail model 122 retrieves the length of a customer's parking facility use for each visit from parking database 125 and compiles an average length of parking facility use per visit for a customer. In another embodiment, customer retail model 122 correlates the average length of parking for a customer from parking database 125 with the average amount of purchases or the amount of customer spending per visit determined from retail transaction data from customer retail database 123. For example, customer A may spend on an average $50 per visit with an average parking facility use time of thirty minutes. In another embodiment, parking model 124 determines for a customer profile the average spending for more than the average parking time. For example, parking model 124 may be configured to determine a customer's average spending for a pre-determined time using the parking facility. For example, parking model 124 analyzing data retrieved from parking database 125 and customer retail database 123 determines that a customer spending a pre-determined short time such as forty-five minutes in the parking facility spends an average of $60. When the same customer uses the parking facility for two hours, the customer spends an average of $600.

In the exemplary embodiment, customer retail model 122 determines a customer spending level. The customer spending level is included in the customer profile. The customer spending level may be determined in one of several ways. For example, a low spending level may be determined by customer retail model 122 for customers whose average spending per visit in the parking facility is in the bottom thirty percent of the average spending per visit for customers using the parking facility with a customer profile. In another example, customer retail model 122 may be configured with a pre-set amount of money to determine a spending level. For example, customers whose average spending per visit exceed a pre-set amount of money may be determined as customers with a high spending level. Similarly, a pre-set monetary amount for a customer's average spending per visit may be set for a low spending level. Customer retail model 122 may use two or more spending levels to determine a spending level for a customer.

Customer retail database 123 resides on server 120. In an embodiment, customer retail database 123 resides on another server, a cloud, or another computing device in distributed data processing environment 100. Customer retail database 123 receives and sends data such as customer retail transaction data from POS devices 141A to 141N and parking model 124. In one embodiment, customer retail database 123 sends and receives data such as POS sales to retail incentive program 121. In one embodiment, customer retail database 123 receives, from parking management device 130, data indicating the length of a customer stay in the parking facility each time the customer uses the parking facility. The data on the length of time the customer stays in the parking facility is stored along with the retail transaction data associated with each parking facility using customer retail database 123. In another embodiment, customer retail database 123 stores customer profiles received from customer retail model 122. POS device transaction data stored in customer retail database 123 includes one or more of the following: customer name, date of a purchase, time of a purchase, amount of a purchase, the amount of total customer purchases for each parking facility stay, product purchased, type of payment for the purchase, store or retailer name, and any other data associated with the POS retail transaction. In an embodiment, retailers agree to share POS transaction data including customer name, size of purchase, type of product, and data/time of purchase. For example, the retailers may have to enter into an agreement or contractual agreement to share select retail transaction data with a facility owner such as a shopping mall, real estate developer or other corporate entity for properties utilizing the parking facility. In another embodiment, only some retailers agree to share some POS retail transaction data. For example, a shoe retailer, three department stores, three specialty stores, and two restaurants agree to send POS transaction data including customer name, purchase value, and purchase date to customer retail database 123. In one embodiment, POS transaction data is not available to customer retail database 123 for customer retail model 122 and is not available to retail incentive program 121.

Parking model 124 resides on server 120. Parking model 124 predicts a parking facility occupancy level based, at least in part, on historical parking facility occupancy data collected by parking management device 130 and stored in parking database 125. Parking model 124 analyzes historical parking facility occupancy levels by one or more of the following: by date, by day of the week, by time, by the number of customer retail transactions per a period of time (e.g., by day or hour), or by holidays to determine the predicted parking occupancy level. In one embodiment, parking model 124 predicts the parking facility occupancy based on historical data of the number of customer retail transactions over a period of time (e.g., a day, four hours, or an hour in a day). In some embodiments, parking model 124 receives real-time parking facility occupancy data from parking management device 130 and incorporates the real-time occupancy data into the model to predict the parking facility occupancy level. In an embodiment, parking model 124 retrieves the real-time parking occupancy data from parking database 125.

In the exemplary embodiment, parking model 124 includes a pre-determined parking facility occupancy alert threshold level. The alert threshold level is a pre-determined predicted parking occupancy level that triggers an alert or notice to be sent from parking model 124 to retail incentive program 121. For example, an alert threshold level for the parking facility may be configured as a predicted parking occupancy level that is 95% of the parking facility occupancy. Parking model 124 sends, via network 110, data such as an alert or notice to retail incentive program 121 when the parking facility is predicted to be at or above the alert threshold level. In various embodiments, parking model 124 includes a pre-determined timeframe for an alert based on a predicted alert threshold level. For example, parking model 124 may be configured or pre-set to provide alerts one half hour in advance of the parking facility attaining a predicted alert threshold level. In this case, parking model 124 predicts based, at least in part, on historical parking records that the parking facility will be at the alert threshold level (e.g., 95% occupancy) in one half hour and an alert is send from parking model 124 to retail incentive program 121 via network 110.

In one embodiment, parking model 124 receives weather advisories such as winter storm warnings from the National Weather Service or other weather prediction service and adjusts parking facility occupancy according to historical parking occupancy data for similar weather events or advisories. In an embodiment, retail incentive program 121 uses school closing notices to update parking model 124 based on historically associated changes to parking occupancy associated with similar school closings. In another embodiment, parking model 124 receives a schedule of events, time of events, and sales for inclusion in parking model 124 from associated retailers or venues, such as a sports arena or a theater whose customers use the parking facility. In one embodiment, parking model 124 receives from municipalities, city planning committees or other locality related scheduling organizations a listing with time and date of municipality related functions such as seasonal festivals, parades, or other similar activities capable of affecting parking facility occupancy levels. In various embodiments of the present invention, the functions and capabilities of retail incentive program 121, customer retail model 122, and parking model 124 may be implemented within a single program, or within one or more programs or modules located elsewhere within distributed data processing environment 100 with access to the information and data stored in customer retail database 123 and parking database 125 via network 110.

Parking database 125 resides on server 120. Parking database 125 receives and stores data on the parking occupancy of the parking facility from parking management device 130 via network 110. Parking database 125 receives the real-time occupancy level of the parking facility associated with parking management device 130. In an embodiment, parking database 125 receives parking data related to other parking facilities. Parking database 125 stores parking facility occupancy levels by date, by day of the week, and by time. In various embodiments, parking database 125 stores parking facility data such as date of customer stay, time of customer entrance and exit, payment information including customer name if available and payment type (e.g., parking pass, smart wallet or debit card number), and length of stay by customer or by customer name as received from parking management device 130. Parking database 125 is capable of sending and receiving data such as parking facility occupancy levels to parking model 124. In the exemplary embodiment, parking database 125 is capable of receiving and sending data such as real-time parking facility occupancy, length of stay by customer, date and time of customer stay, payment information including payment method (e.g., smart wallet or credit card number) and customer name to customer retail model 122 and retail incentive program 121. In various embodiments of the present invention, the information and data stored in customer retail database 123 and parking database 125 may be stored in a single database, or on one or more databases located elsewhere in distributed data processing environment 100, accessible via network 110.

Parking management device 130 and POS devices 141A to 141N can each be a tablet computer, a laptop computer, a hand-held computing device, a specialized computer device or server, or any programmable electronic device capable of communicating with various components and devices within distributed data processing environment 100, via network 110. Parking management device 130 and POS devices 141A to 141N each include the capability to read or scan customer data from a parking pass, coupon, electronic ID, smart phone payment application such as a mobile payment application, send and receive information including financial transactions such as payments from a user or a customer including cash where the cash payment may be tracked because the customer may also use a reward card, parking number, a ticket, a coupon, or a store card. A mobile payment application or mobile payment refers to payment services operated under financial regulation and performed from or via a mobile device such as a smart phone, other mobile electronic or computing device. A mobile payment may also be referred to as mobile money, mobile money transfer, and mobile wallet. In general, parking management device 130 and POS devices 141A to 141N each represent any programmable electronic device or combination of programmable electronic devices capable of executing machine readable program instructions and communicating with other computing devices (not shown) within distributed data processing environment 100 via a network, such as network 110.

Parking management device 130 is a computing device connected via network 110 to server 120. Parking management device 130 includes scanner 133 and user interface (UI) 135. Parking management device 130, using methods known in the art, is capable of recording vehicle entry and exit from a parking facility, receiving parking payment, and determining the real-time occupancy of the parking facility. Parking management device 130 with scanner 133 and UI 135 is capable of reading and recording a customer parking pass, a smart phone payment application, a customer store card, a Quick Response Code (QR®) code, or other form of customer identification for a customer vehicle entering or leaving the parking facility. Parking management device 130 may receive customer identification information at one or more remote scanning devices at parking facility entrances and exits, such as parking kiosks or parking scanners in a location remote from parking management device 130. Parking management device 130 determines, in real-time, the number customer vehicles in the parking facility. In the exemplary embodiment, parking management device 130 determines the real-time parking facility occupancy level, which may be, for example, a percentage of the parking spaces currently in use or 80% of the total parking spaces are in use (e.g., 240 of 300 available parking spaces are in use).

Scanner 133 reads customer parking passes, credit cards, or other scanned customer identification or payment methods. Scanner 133 reads a scanned medium such as a credit card or parking pass or other electronically detectable medium including infrared or other data transmission method enabling a customer to transmit or communicate data for vehicle entry, exit, and payment to parking management device 130. Parking management device 130 is capable of performing financial transactions as known in the art for the parking facility including credit/debit card transactions, smart phone application transactions, cash, or automatic parking pass payments. In an embodiment, parking management device 130 retrieves the customer name from customer parking payment such as a credit, debit, or mobile payment application, and when applicable, the customer cell phone number, e-mail address, or smart phone number from scanned or received customer data for customers entering the parking facility. In this case, parking management device 130 includes the customer name and/or cell phone number for customers entering the parking facility with the information sent and stored in parking database 125. In one embodiment, when a customer uses a cash method of payment a customer identification is determined by one of: matching the customers store purchases to a parking number, ticket, or coupon, and facial recognition.

UI 135 provides an interface between a user and parking management device 130. UI 135 may be a graphical user interface (GUI) or a web user interface (WUI) and can access application interfaces, display text, documents, web browser windows, user options, and instructions for operation, and includes the information (such as graphic, text, and sound) that a program presents to a user and the control sequences the user employs to interact with parking management device 130. UI 135 may also be mobile application software that provides an interface between a user and parking management device 130. Mobile application software, or an “app,” is a computer program designed to run on smart phones, tablet computers and other mobile devices. UI 135 enables a user of parking management device 130 to communicate data or information for entry, exit, and payment to parking management device 130. In an embodiment, an administrator or operator of UI 135 configures parking management device 130 to send data on real-time parking facility occupancy on predetermined time intervals to parking database 125 via network 110, for example, every 15 minutes.

POS devices 141A to 141N are computing devices with the capability for point of sale transactions. POS devices 141A to 141N provide the ability to scan barcode and pricing, read credit/debit cards or mobile payment applications present on a smartphone, verify financial data such as credit and debit card numbers, and provide currency exchange (i.e., cash register capability) as known in the art. POS devices 141A to 141N are each one of a plurality of computing devices used by one or more retail stores, restaurants, salons, or other retailers to record and process financial transactions such as a product sale for a retail establishment. For example, POS device 141A for a retailer such as a department store reads, scans, records and provides financial transactions for purchases including cash for sales within the store. In another example, POS device 141N may be used when the customer purchases a service, for example, a hairstyle and the retail transaction data associated with the purchase is sent to customer retail database 123. If a customer pays in cash, the customer identification for sending data to customer retail database 123 may be done when a store reward card or other similar reward tracking system is used at checkout by the POS device. In an embodiment, a retailer has multiple POS devices operating in the store. POS devices 141A to 141N have the capability to receive and send data such as data and information on retail and customer transactions to and from customer retail database 123 on server 120, for example, via network 110. Information on customer transactions may include customer payment information such as customer name when available through the transaction, by a store card or other customer identifying application (e.g., customer code, identification tag, or facial recognition programs if used) and purchase information. Purchase information may include a value of the purchase, the number of items purchased, time of purchase, and the type of items purchased. In an embodiment, only POS devices from some retailers associated with or using the parking facility managed by parking management device 130 provide customer transaction information to customer retail database 123. For example, a retail store using POS device 141A elects not to send customer transaction data to customer retail database 123. In an embodiment, a retailer is a sports arena, a theater, a restaurant, a museum, or other type of establishment utilizing the parking facility managed by parking management device 130. For example, a retailer using POS device 141N may be a theater.

Smart phone 150 is smart phone, a personal digital assistant, a wearable computer such as a smart watch, a tablet computer, a laptop computer, a hand-held computing device, a specialized computer device, or any programmable electronic device capable of communicating with various components and devices within distributed data processing environment 100, via network 110. In various embodiments, smart phone 150 may include a retail incentive application, where the retail incentive application is capable of sending and receiving information and data such as retail incentives from retail incentive program 121 via network 110. While only one smart phone 150 is depicted in FIG. 1, as one skilled in the art understands, multiple customers using multiple smart phones or other portable electronic devices or computing devices (not shown in FIG. 1) may be present in the distributed data processing environment 100. Smart phone 150 is capable of sending and receiving data from server 120 and may, in some embodiments, send and receive data from parking management device 130 and/or POS devices 141A to 141N. In some embodiments, smart phone 150 includes a smart phone payment application such as a smart wallet. In general, smart phone 150 represents any programmable electronic device or combination of programmable electronic devices capable of executing machine readable program instructions and communicating with other computing devices (not shown) within distributed data processing environment 100 via a network, such as network 110.

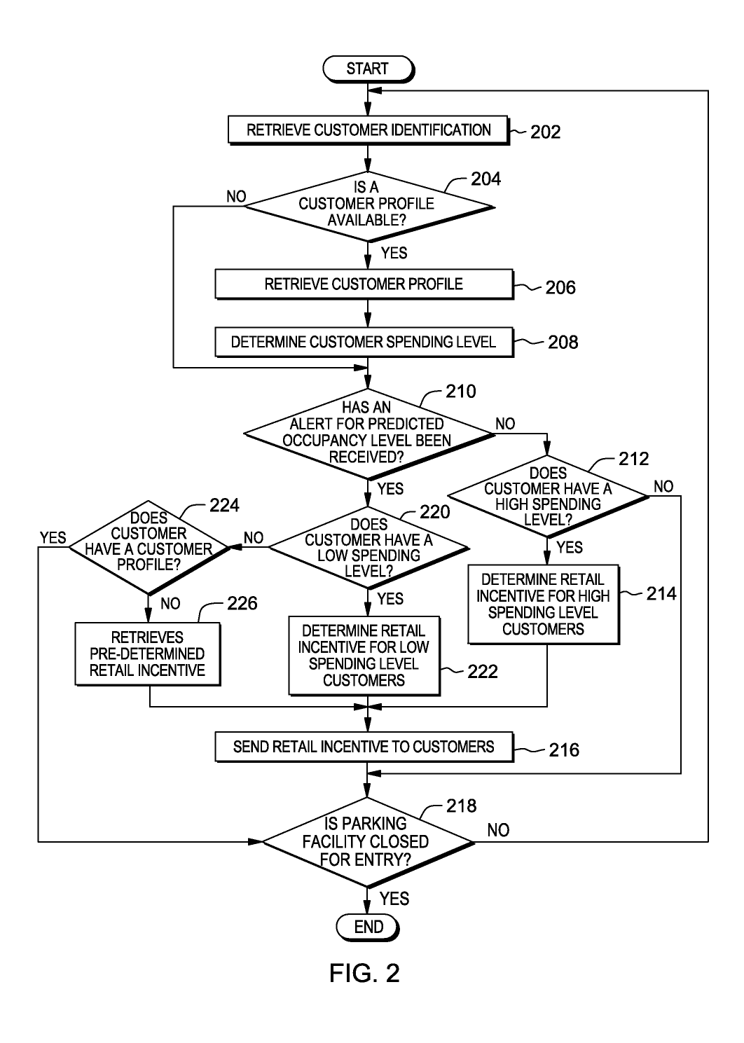

FIG. 2 is a flowchart 121 depicting operational steps of retail incentive program 121, on server 120 within distributed data processing environment 100, for determining retail incentives for customers using a parking facility, in accordance with an embodiment of the present invention. Retail incentive program 121 retrieves customer identification (202). Retail incentive program 121 may retrieve customer identification such as a customer name or a cell phone number from several sources including parking pass data, credit/debit card data, store reward card data, mobile payment, other form of customer payment and/or identification provided to parking management device 130 or POS devices 141A to 141N. In various embodiments, retail incentive program 121 is configured to start or refresh in a set period of time. For example, retail incentive program 121 is configured to run or refresh every fifteen minutes. In this case, retail incentive program 121 may retrieve customer identification from parking database 125 or customer retail database 123. In some embodiments, customer identification may be retrieved from parking database 125 after being scanned, read or otherwise provided to parking management device 130 and sent to parking database 125. Additionally, customer identification may be retrieved from customer retail database 123 when customers make purchases at retailers using payment information such as credit/debit card numbers in another embodiment.

In another embodiment, retail incentive program 121 receives customer identification from parking management device 130 when the customer enters the parking facility. In another embodiment, retail incentive program 121 receives customer identification from POS devices 141A to 141N and parking management device 130.

Retail incentive program 121 determines if a customer profile is available (decision 204). Retail incentive program 121 queries or searches customer retail database 123 for a customer profile for the customer. In various embodiments, the customer profile created by customer retail model 122 is based on data from POS transaction data generated by POS devices 141A to 141N and from customer related data retrieved from parking database 125. When no customer profile is available (no branch, decision 204), retail incentive program 121 determines if an alert is received (decision 210).

If a customer profile is available for the customer (e.g., by customer name, credit/debit card number, mobile payment, store reward card or other financial transaction record) (yes branch, decision 204), then, retail incentive program 121 retrieves the customer profile (206). The customer profile including for example, the customer name, the customer spending level, the average customer spending per visit, and other information gathered on the customer based on customer POS transaction data including POS transaction data from parking management device 130 on length of stay may be retrieved by retail incentive program 121 from customer retail database 123. In an embodiment, retail incentive program 121 receives the customer profile from a user computing device such as smartphone 150 input or sent by the customer upon entering the parking facility. If the POS transaction data for the customer is the first purchase at a retailer associated with the parking facility, the POS transaction sent to customer retail database 123 and customer retail model 122 may be used to create a customer profile for the customer. Upon retrieving the customer profile, retail incentive program 121 determines the customer spending level (208). The customer spending level for the customer is stored in the customer profile. Using the spending level data extracted from the customer profile, retail incentive program 121 identifies the customer spending level. In an embodiment, the customer spending level extracted from the customer profile may identify the customer as associated with a high or a low spending level based on the analysis of the customer's historical spending patterns by customer retail model 122.

Upon determining the customer spending level, retail incentive program 121 determines if an alert for the predicted parking occupancy level is received (decision 210). The alert is sent with a pre-determined timeframe or with a pre-determined lead-time for attaining the predicted alert threshold level. In the exemplary embodiment, the alert is sent a pre-determined time ahead of when the predicted parking occupancy level is expected to attain the alert threshold level. In other words, parking model 122 may be configured, to send the alert to retail incentive program 121 thirty minutes before the parking occupancy level is predicted to attain the alert threshold level. If an alert is received that the predicted parking occupancy level is expected to attain the alert threshold level in the pre-determined time (yes branch, decision 210), then, retail incentive program 121 determines if the customer has a low spending level (decision 220).

If retail incentive program 121 determines the customer has a low spending level, based on the retrieved customer profile (yes branch, decision 220), then retail incentive program 121 determines the retail incentives for the customer with a low spending level (222). In an exemplary embodiment, retail incentive program 121 analyzes the customer profile to determine each customer with a low spending level. In one embodiment, for customers with a low spending level, retail incentive program 121 analyzes the customer profile to determine if the customer commonly makes a final purchase of a shopping visit in a specific retail establishment. For example, if one customer usually stops at a coffee shop before exiting the parking facility, based on the customer profile, then retail incentive program 121 determines a retail incentive encouraging the customer to visit the coffee shop by offering a 5% parking discount for a purchase in the coffee shop, or a 5% discount on coffee. In an embodiment, retail incentive program 121 may further encourage an exit by requiring the coffee shop purchase in a certain period of time, for example, the next thirty minutes, or offering an additional discount on parking for a purchase in the coffee shop in a pre-determined period of time. In another embodiment, retail incentive program 121 offers a retail incentive such as a parking discount for a purchase in the store from which the customer most frequently makes purchases. For example, a most frequented or favorite store may be indicated by a customer purchase at the store on each previous parking facility visit over a period of time, for example, three months. If retail incentive program 121 identifies from the customer profile a customer purchases a book at a bookstore on three consecutive shopping trips, or in another example, on ten visits over a three-month period, then retail incentive program 121 can provide a 10% parking discount for a purchase at this store. In one embodiment, retail incentive program 121 offers a retail incentive or a parking discount based on the amount of the current customer purchases for the day and an average amount the customer spends on an average visit or stay in the parking facility. For example, if a customer spends an average amount of $100 in a typical visit and has spent $30 so far this visit, then retail incentive program 121 may offer a first 5% parking discount when the customer spends another $40 in the next thirty minutes and an additional or second 5% discount if the customer spends $80 in the next thirty minutes.

In one embodiment, when an alert is received for the predicted parking occupancy level, retail incentive program 121 is configured with pre-determined retail incentives provided by the various retailers whose customers use the parking facility. The retailer provided pre-determined retail incentive may be offered to the customers when an alert is received. In another embodiment, the retailer provided incentives may be provided to select customers (e.g., low spending customers, any customer, or customers identified to retail incentive program 121 by the retailer). The pre-determined retail incentives may be updated by retail incentive program 121 based on additional data or incentives provided by the retailers.

Once retail incentive program 121 determines the retail incentive for the customers with a low spending level, then retail incentive program 121 sends the retail incentive to the customers (216). In an embodiment, the retail incentives are sent via an application or mobile app on a smartphone or other electronic device to customers with a low spending level. In another embodiment, the retail incentives are sent to the customer's cellphone or other mobile electronic device using a text, an e-mail, or other form of electronic notification.

After sending the retail incentive to the customer, retail incentive program 121 determines if the parking facility is closed (decision 218). If the parking facility is not closed (no branch, decision 218), then retail incentive program 121 returns to retrieve further customer identification (202) and checks to see if additional customers have arrived. If the parking facility is closed for entry (yes branch, 218), then retail incentive program 121 ends processing.

If retail incentive program 121 determines the customer does not have a low spending level (no branch, decision 220), then the program determines if the customer has a customer profile (decision 224). If the customer has a customer profile (yes branch, decision 224), then, retail incentive program 121 determines if the parking facility is closed for entry (decision 218).

If the customer does not have a customer profile (no branch, decision 224), then retail incentive program 121 uses a pre-determined retail incentive (226). In the exemplary embodiment, retail incentive program 121 includes a pre-determined and configured retail incentive, for example, a parking discount, to offer identified customers without a customer profile (e.g., without historical POS transaction data for the customer used by customer retail model 122 to create a customer profile). For example, retail incentive program 121 may be configured to offer customers without a customer profile or known spending level a 5% parking discount with a $30 purchase when an alert is received. In another embodiment, retail incentive program 121 includes a timeframe in which to complete a retail transaction to receive a retail incentive such as a parking discount. In this example, when retail incentive program 121 receives an alert that the parking facility occupancy level is predicted to be at the parking occupancy threshold level in a half hour (the pre-defined timeframe for the alert), retail incentive program 121 may offer a 5% parking discount for a $20 purchase in the next half hour. In another example, retail incentive program 121 may be configured to offer a 5% parking discount when $20 in purchases are made in the next half hour and a 10% parking discount if $100 in purchases are made in the next half hour thus, further encouraging customers to make even more purchases in a timely manner. In this example, retail incentive program 121 offers a general, non-specific retail incentive to customers without associated POS transaction data or a customer profile encouraging them to make purchases and exit the parking facility when an alert is received.

Retail incentive program 121 sends the retail incentive to the customers (216). The retail incentives may be sent to the customer's electronic device such as smartphone 150 and received by a smart phone application, a text, an e-mail, or another form of electronic communication. Upon sending the retail incentive, retail incentive program 121 determines if the parking facility is closed for entry (decision 218). If the parking facility is not closed (no branch, decision 218), then retail incentive program 121 returns to further retrieve customer identification information for any additional customers (202). If the parking facility is closed for entry (yes branch decision, 218), then retail incentive program 121 ends processing.

If retail incentive program 121 determines that no alert has been received the parking occupancy threshold (no branch, decision 210), then retail incentive program 121 determines if the customer has a high spending level (decision 212). If the customer does not have a high spending level (no branch, decision 212), retail incentive program 121 determines if the parking facility closed for entry (decision 218). Retail incentive program 121 may determine a customer does not have a high spending level when either POS transaction data is not available for the customer, or if the customer profile indicates the customer does not have a high spending level. If the parking facility is not closed (no branch, decision 218), then retail incentive program 121 returns to retrieve customer identification for any additional customers to the parking facility (202). If the parking facility is closed for entry (yes branch, decision 218), then retail incentive program 121 ends processing.

If retail incentive program 121 determines that the customer has a high spending level (yes branch, decision 212), then retail incentive program 121 determines a retail incentive for the high spending customer (214). When parking facility congestion is not an issue, retail incentive program 121 encourages customers with a high spending level to spend more by offering parking discounts or other retail incentives for additional purchases. The retail incentive encouraging high spending customers to stay and spend more when the parking facility is not predicted to be congested or at the alert threshold level may be determined by retail incentive program 121 using one or more methods.

In one embodiment, retail incentive program 121 analyzes a customer profile for customers with a high spending level to determine the customer's average spending by visit or by each parking facility use and based, at least in part, on the customers average spending determines a parking discount associated with the customer's average spending. For example, retail incentive program 121 may be configured to offer a 5% parking discount to the customer for a total purchase value equal to the average spending per visit for the customer and a 10% parking discount for total purchase value that is 30% more that the customer's average spending per visit.

In another embodiment, retail incentive program 121 analyzes the customer's profile to determine if a significant percentage (in terms of monetary amount spent) of the customer's purchases are made at one retail establishment and if so, the program offers a retail incentive for that store. For example, retail incentive program 121 determines a customer frequently purchases high-end designer shoes from a specific establishment, and response, offers a 5% parking discount for a purchase from the establishment.

In an embodiment, retail incentive program 121 analyzes the high spending customer profile to determine if shopping patterns exist for the customer and, determining a shopping pattern, offers a retail incentive associated to the pattern. In the example above, retail incentive program 121 determines that the customer who purchases high-end designer shoes usually purchases clothing from one or two clothing retailers, in this case, retail incentive program 121 may be configured to offer an additional 5% parking discount for purchases totaling more than $700 from the two clothing retailers.

In some embodiments, retail incentive program 121 may analyze a high spending customer profile to determine a retail incentive for a specific item purchase associated with the customer's favorite purchase item. For example, retail incentive program 121 analyzes a customer profile and determines that a customer purchases two to three times from a specialty tie retailer in most visits to the facility, and in response, retail incentive program 121 may offer a retail incentive such as a 5% parking discount for a purchase of three ties from the specially tie retailer.

Once the retail incentive has been determined for the customer with a high spending level by retail incentive program 121, and then retail incentive program 121 sends the retail incentive to the high spending customers (216). The retail incentive for high spending customers is sent to the customers via a smartphone application, an e-mail or another electronic notification such as a text generated by retail incentive program 121 for cell phone numbers retrieved from parking database 125 for customers without smart phones. When retail incentive program 121 sends the retail incentive to the high spending customers, then retail incentive program 121 sends a query to parking management device 130 to determine whether the parking facility is closed for entry (decision 218). If the parking facility is not closed (no branch, decision 218), retail incentive program 121 returns to retrieve customer identification information for any additional customers of the parking facility (202). When the parking facility is closed for entry (yes branch, decision 218), then retail incentive program 121 ends processing.

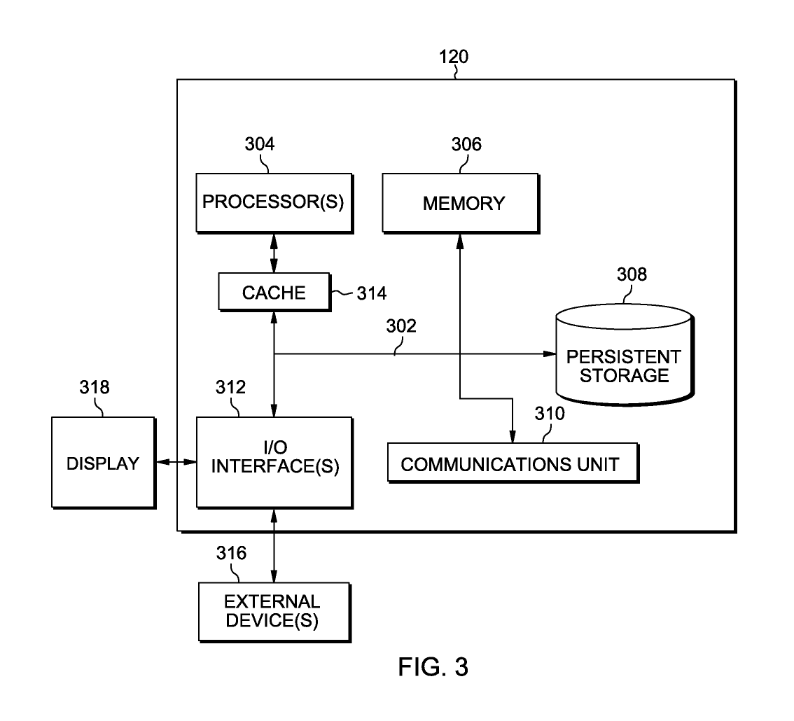

FIG. 3 depicts a block diagram of components of a computer system, which is an example of a system such as server 120 within distributed data processing environment 100, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server 120 includes processor(s) 304, cache 314, memory 306, persistent storage 308, communications unit 310, input/output (I/O) interface(s) 312, and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention are stored in persistent storage 308 for execution and/or access by one or more of the respective processor(s) 304 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is part of persistent storage 308.

Communications unit 310, in these examples, provides for communications with other data processing systems or devices, including resources of server 120, parking management device 130, POS devices 141A to 141N, smart phone 150, and other computing devices not shown in FIG. 1. In these examples, communications unit 310 includes one or more network interface cards. Communications unit 310 may provide communications with either or both physical and wireless communications links. Program instructions and data used to practice embodiments of the present invention may be downloaded to persistent storage 308 through communications unit 310.

I/O interface(s) 312 allows for input and output of data with other devices that may be connected to server 120. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media, for example, devices such as thumb drives, portable optical or magnetic disks, and memory cards. Software and data used to practice embodiments of the present invention can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

1.-8. (canceled)

9. A computer program product to manage parking facility occupancy, the computer program product comprising:
one or more computer readable storage media and program instructions stored on the one or more computer readable storage media, the program instructions executable by a processor, the program instructions comprising:
program instructions to retrieve a customer identification for a customer entering a parking facility;
program instructions to determine whether a customer profile is available for the customer;
responsive to determining the customer profile is available for the customer, program instructions to retrieve the customer profile from a database;
program instructions to determine, based, at least in part, on the customer profile, a customer spending level for the customer;
program instructions to determine, whether an alert is received, the alert indicating a parking facility occupancy level is predicted to attain an alert threshold level; and
responsive to determining the alert is received, program instructions to determine a retail incentive for the customer, based, in part, on the customer spending level.

10. The computer program product of claim 9, further comprises program instructions to send the retail incentive to the customer.

11. The computer program product of claim 9, wherein the retail incentive for the customer includes a first discount when the customer completes one or more additional retail transactions.

12. The computer program product of claim 9, wherein determining the retail incentive for the customer, based, in part, on the customer spending level further comprises:
program instructions to determine whether the customer profile indicates a low spending level;
responsive to determining the customer profile indicates a low spending level, program instructions to determine the retail incentive for the customer, based, in part, on the indicated low spending level.

13. The computer program product of claim 9, further comprising:
responsive to determining the alert is not received, program instructions to determine whether the customer profile indicates a high spending level; and
responsive to determining the customer profile indicates a high spending level, program instructions to determine the retail incentive for the customer, based, in part, on the indicated high spending level.

14. The computer program product of claim 9, wherein the retail incentive includes one or more retail incentives associated with a customer average spending, a store the customer most frequently purchases from, a customer shopping pattern, a parking facility discount, a retailer provided incentive, and a pre-determined retail incentive.

15. The computer program product of claim 9, further comprising:
responsive to determining the customer profile is not available for the customer, program instructions to retrieve a pre-determined retail incentive for the customer, wherein the pre-determined retail incentive includes at least one of a parking discount and an incentive to complete a purchase.

16. A computer system to manage parking facility occupancy, the computer system comprising:
one or more computer processors;
one or more computer readable storage media;
program instructions stored on the one or more computer readable storage media for execution by at least one of the one or more processors, the program instructions comprising:
program instructions to retrieve a customer identification for a customer entering a parking facility;
program instructions to determine whether a customer profile is available for the customer;
responsive to determining the customer profile is available for the customer, program instructions to retrieve the customer profile from a database;
program instructions to determine, based, at least in part, on the customer profile, a customer spending level for the customer;
program instructions to determine, whether an alert is received, the alert indicating a parking facility occupancy level is predicted to attain an alert threshold level; and
responsive to determining the alert is received, program instructions to determine a retail incentive for the customer, based, in part, on the customer spending level.

17. The computer system of claim 16, further comprises program instructions to send the retail incentive to the customer.

18. The computer system of claim 16, wherein the retail incentive for the customer includes a first discount when the customer completes one or more additional retail transactions.

19. The computer system of claim 16, wherein determining the retail incentive for the customer, based, in part, on the customer spending level further comprises:
program instructions to determine whether the customer profile indicates a low spending level;
responsive to determining the customer profile indicates a low spending level, program instructions to determine the retail incentive for the customer, based, in part, on the indicated low spending level.

20. The computer system of claim 16, further comprises:
responsive to determining the customer profile is not available for the customer, program instructions to retrieve a pre-determined retail incentive for the customer, wherein the pre-determined retail incentive includes at least one of a parking discount and an incentive to complete a purchase.
